(19) United States
(12) Patent Application Publication
(10) Pub. No.: US 2013/0314211 A1
(43) Pub. Date: Nov. 28, 2013

(54) CONTAINER-TYPE IDENTIFICATION USING DIRECTIONAL-ANTENNA RFID

(71) Applicants: Mark P. Hinman, Holley, NY (US); Donald Saul Rimai, Webster, NY (US); Edward Zogg, Ontario, NY (US)

(72) Inventors: Mark P. Hinman, Holley, NY (US); Donald Saul Rimai, Webster, NY (US); Edward Zogg, Ontario, NY (US)

(21) Appl. No.: 13/477,195

(22) Filed: May 22, 2012

(51) Int. Cl. G06K 7/01

(52) U.S. Cl. 340/10.1

(57) ABSTRACT

RFID tags are read using an RFID reader. A non-RFID-active object has two RFID tags affixed thereto at respective, different tag locations. Each tag has a respective directional antenna steered in a respective, different direction. Respective directional propagation patterns are thus defined and a reader location is defined in the intersection of the propagation patterns. An RFID reader with a reader antenna located at the reader location is provided. The RFID reader is activated to read both tags.

### CROSS-REFERENCE TO RELATED APPLICATIONS

This application has related subject matter to U.S. patent application Ser. No. ______ (attorney docket No. K000945) filed herewith, titled “CONTAINER-CLASSIFICATION IDENTIFICATION USING DIRECTIONAL-ANTENNA RFID,”and U.S. patent application Ser. No. ______ (attorney docket No. K000946), filed herewith, titled “RFID MARKING OF UNITS IN A SPACE” the disclosures of which are hereby incorporated herein by reference.

### FIELD OF THE INVENTION

This invention pertains to the field of radio-frequency communication between radio-frequency identification (RFID) tags and RFID readers, and more particularly to making it more difficult to perform unauthorized reads of tag data.

### BACKGROUND OF THE INVENTION

Various electronic equipment or devices can communicate using wireless links. A popular technology for communication with low-power portable devices is radio frequency identification (RFID). Standardized RFID technology provides communication between an interrogator (or “reader”) and a “tag” (or “transponder”), a portable device that transmits an information code or other information to the reader. Tags are generally much lower-cost than readers. RFID standards exist for different frequency bands, e.g., 125 kHz (LF, inductive or magnetic-field coupling in the near field), 13.56 MHz (HF, inductive coupling), 433 MHz, 860-960 MHz (UHF, e.g., 915 MHz, RF coupling beyond the near field), 2.4 GHz, or 5.8 GHz. Tags can use inductive, capacitive, or RF coupling (e.g., backscatter, discussed below) to communicate with readers. Although the term “reader” is commonly used to describe interrogators, “readers” (i.e., interrogators) can also write data to tags and issue commands to tags. For example, a reader can issue a “kill command” to cause a tag to render itself permanently inoperative. RFID readers and tags can communicate using, e.g., the EPC Class-1 Generation-2 UHF RFID Protocol for Communications at 860 MHz-960 MHz, Version 1.2.0, Oct. 23, 2008, incorporated herein by reference.

Radio frequency identification systems are typically categorized as either “active” or “passive.” In an active RFID system, tags are powered by an internal battery, and data written into active tags can be rewritten and modified. In a passive RFID system, tags operate without an internal power source, instead being powered by received RF energy from the reader. “Semi-active” or “semi-passive” tags use batteries for internal power, but use power from the reader to transmit data. Passive tags are typically programmed with a unique set of data that cannot be modified. A typical passive RFID system includes a reader and a plurality of passive tags. The tags respond with stored information to coded RF signals that are typically sent from the reader. Further details of RFID systems are given in commonly-assigned U.S. Pat. No. 7,969,286 to Adelbert, and in U.S. Pat. No. 6,725,014 to Voegele, both of which are incorporated herein by reference.

In a commercial or industrial setting, tags can be used to identify containers of products used in various processes. A container with a tag affixed thereto is referred to herein as a “tagged container.” Tags on containers can carry information about the type of products in those containers and the source of those products. For example, as described in the GS1 EPC Tag Data Standard ver. 1.6, ratified Sep. 9, 2011, incorporated herein by reference, a tag can carry a “Serialized Global Trade Item Number” (SGTIN). Each SGTIN uniquely identifies a particular instance of a trade item, such as a specific manufactured item. For example, a manufacturer of cast-iron skillets can have, as a “product” (in GS1 terms) a 10″ skillet. Each 10″ skillet manufactured has the same UPC code, called a “Global Trade Item Number” (GTIN). Each 10″ skillet the manufacturer produces is an “instance” of the product, in GS1 terms, and has a unique Serialized GTIN (SGTIN). The SGTIN identifies the company that makes the product and the product itself (together, the GTIN), and the serial number of the instance. Each box in which a 10″ skillet is packed can have affixed thereto an RFID tag bearing the SGTIN of the particular skillet packed in that box. SGTINs and related identifiers, carried on RFID tags, can permit verifying that the correct products are used at various points in a process.

However, RFID tags in general, and specifically passive tags, often do not have enough processing power or memory to perform cryptographic authentication or authorization functions, such as secure hashing with time-varying salt. Consequently, every read of a tag returns the same data. As a result, RFID systems can be vulnerable to attacks in which a rogue (non-authorized) reader placed near a tag reads and stores that tag's data. This process is called “skimming,” and such rogue readers are referred to as “skimmers.” The skimmer can later replay the stored data (a “replay attack”) to pretend to be the skimmed tag (“spoofing”). This can result in incorrect products being used in industrial or commercial processes, or mishandled inventory in a retail environment, possibly resulting in lost productivity or wasted product. Skimmers can actively interrogate RFID tags, or passively wait and record data sent by tags being interrogated by authorized readers. In other cases, skimmers can passively record the data transfers by which an authorized reader opens a communications session with an RFID tag. The skimmer can then use this information to open a communications session with the RFID tag and make unauthorized changes to data stored on the tag.

Various schemes have been proposed to reduce vulnerability of RFID systems to skimmers. U.S. Patent Publication No. 2009/0174556 by Home et al. describes an RFID blocker that disrupts an RFID reader's signal to a tag when the blocker is physically near the tag. However, the blocker will disrupt all accesses, not just unauthorized access. In another scheme, U.S. Patent Publication No. 2009/0021343 by Sinha describes jamming or spoofing skimmers, either using authorized electronics or intrusion-prevention tags, in response to intrusions or policy violations. U.S. Pat. No. 7,086,587 to Myllymaki describes RFID readers that can detect unauthorized tags, and tags that can detect unauthorized readers. However, none of these schemes reduces the probability of passive monitoring by a skimmer during an authorized read of the tag. Various prior-art schemes use readers with directional antennas to reduce the area of operation in which a skimmer can detect that a read is in progress.

There is, therefore, a continuing need for a way of detecting an RFID tag while reducing the vulnerability of the tag to skimming. There is also a continuing need for ways to use RFID technology to reliably identify attributes of the objects to which they are attached.

### SUMMARY OF THE INVENTION

According to an aspect of the present invention, there is provided a method of identifying a type of a container, the method comprising:

providing the container having two RFID tags affixed thereto at respective, different tag locations, each tag including a respective directional antenna steered in a respective, different direction, so that respective directional propagation patterns are defined and a reader location is defined in an intersection of the propagation patterns;

providing an RFID reader with a reader antenna located in the reader location;

activating the RFID reader to attempt to read both tags; and

using a controller, automatically determining that the container is of a selected type if both tags are read, and that the container is not of the selected type if either tag is not read.

According to another aspect of the present invention, there is provided a method of reading a plurality of RFID tags using an RFID reader, comprising:

providing a non-RFID-active object having two RFID tags affixed thereto at respective, different tag locations, each tag including a respective directional antenna steered in a respective, different direction, so that respective directional propagation patterns are defined and a reader location is defined in the intersection of the propagation patterns;

providing an RFID reader with a reader antenna located at the reader location; and

activating the RFID reader to read both tags.

An advantage of this invention is that it uses directional tag antennas with a selected reader antenna, which can be omnidirectional. Various embodiments advantageously provide an identified reader location at which data from the tags can be read. A skimmer at another location cannot successfully skim all of the data for the package. Various embodiments use standards-compliant, off-the-shelf readers and tags, only requiring customization of the tag antennas. Various embodiments use multiple antennas to detect attempts by skimmers to emulate (“spoof”) valid tag signals.

### BRIEF DESCRIPTION OF THE DRAWINGS

The above and other objects, features, and advantages of the present invention will become more apparent when taken in conjunction with the following description and drawings wherein identical reference numerals have been used, where possible, to designate identical features that are common to the figures, and wherein:

FIG. 1 is a block diagram of an RFID system according to various embodiments;

FIG. 2 is a block diagram of a passive RFID tag according to various embodiments;

FIG. 3 is a high-level diagram showing the components of a processing system useful with various embodiments;

FIG. 4 shows radio-frequency identification (RFID) apparatus according to various embodiments;

FIG. 5 shows antenna configurations according to various embodiments;

FIG. 6 shows methods of reading a plurality of RFID tags using an RFID reader according to various embodiments; and

FIG. 7 shows various embodiments of methods of identifying a type of a container, or of testing whether a container is of a particular type.

The attached drawings are for purposes of illustration and are not necessarily to scale.

### DETAILED DESCRIPTION OF THE INVENTION

In the following description, some embodiments will be described in terms that would ordinarily be implemented as software programs. Those skilled in the art will readily recognize that the equivalent of such software can also be constructed in hardware. Because image manipulation algorithms and systems are well known, the present description will be directed in particular to algorithms and systems forming part of, or cooperating more directly with, methods described herein. Other aspects of such algorithms and systems, and hardware or software for producing and otherwise processing the image signals involved therewith, not specifically shown or described herein, are selected from such systems, algorithms, components, and elements known in the art. Given the system as described herein, software not specifically shown, suggested, or described herein that is useful for implementation of various embodiments is conventional and within the ordinary skill in such arts.

A computer program product can include one or more storage media, for example; magnetic storage media such as magnetic disk (such as a floppy disk) or magnetic tape; optical storage media such as optical disk, optical tape, or machine readable bar code; solid-state electronic storage devices such as random access memory (RAM), or read-only memory (ROM); or any other physical device or media employed to store a computer program having instructions for controlling one or more computers to practice methods according to various embodiments.

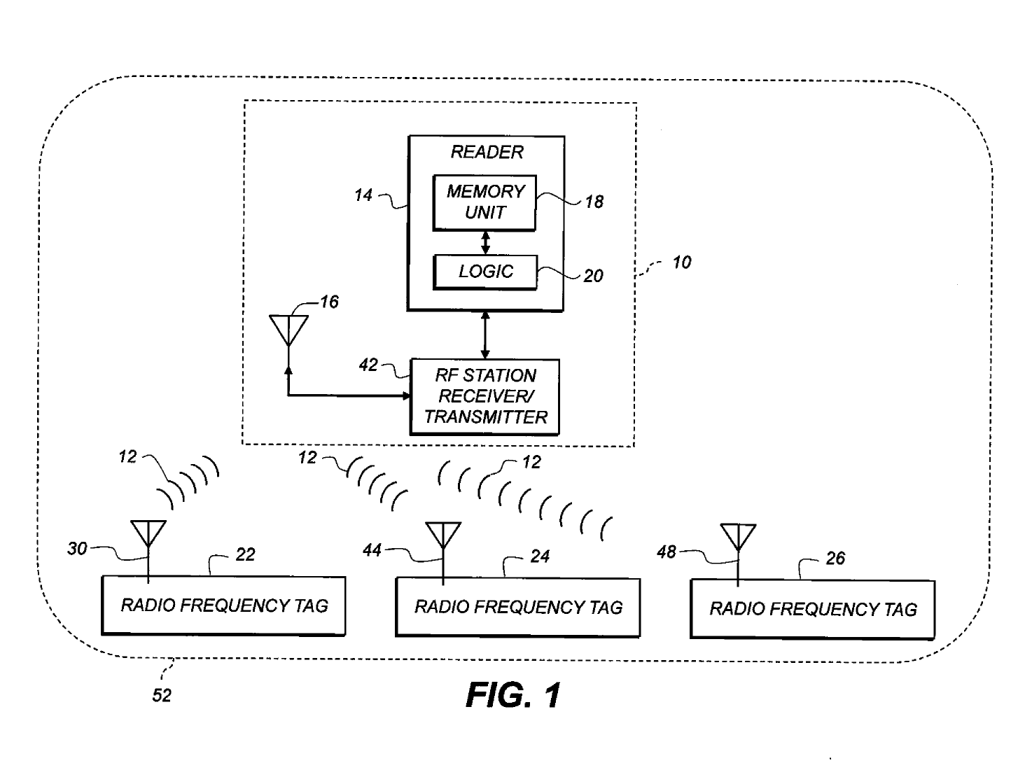

FIG. 1 is a block diagram of an RFID system according to various embodiments. Base station 10 communicates with three RF tags 22, 24, 26, which can be active or passive in any combination, via a wireless network across an air interface 12. FIG. 1 shows three tags, but any number can be used. Base station 10 includes reader 14, reader's antenna 16 and RF station 42. RF station 42 includes an RF transmitter and an RF receiver (not shown) to transmit and receive RF signals via reader's antenna 16 to or from RF tags 22, 24, 26. Tags 22, 24, 26 transmit and receive via respective antennas 30, 44, 48.

Reader 14 includes memory unit 18 and logic unit 20. Memory unit 18 can store application data and identification information (e.g., tag identification numbers) or SG TINs of RF tags in range 52 (RF signal range) of reader 14. Logic unit 20 can be a microprocessor, FPGA, PAL, PLA, or PLD. Logic unit 20 can control which commands that are sent from reader 14 to the tags in range 52, control sending and receiving of RF signals via RF station 42 and reader's antenna 16, or determine if a contention has occurred.

Reader 14 can continuously or selectively produce an RF signal when active. The RF signal power transmitted and the geometry of reader's antenna 16 define the shape, size, and orientation of range 52. Reader 14 can use more than one antenna to extend or shape range 52.

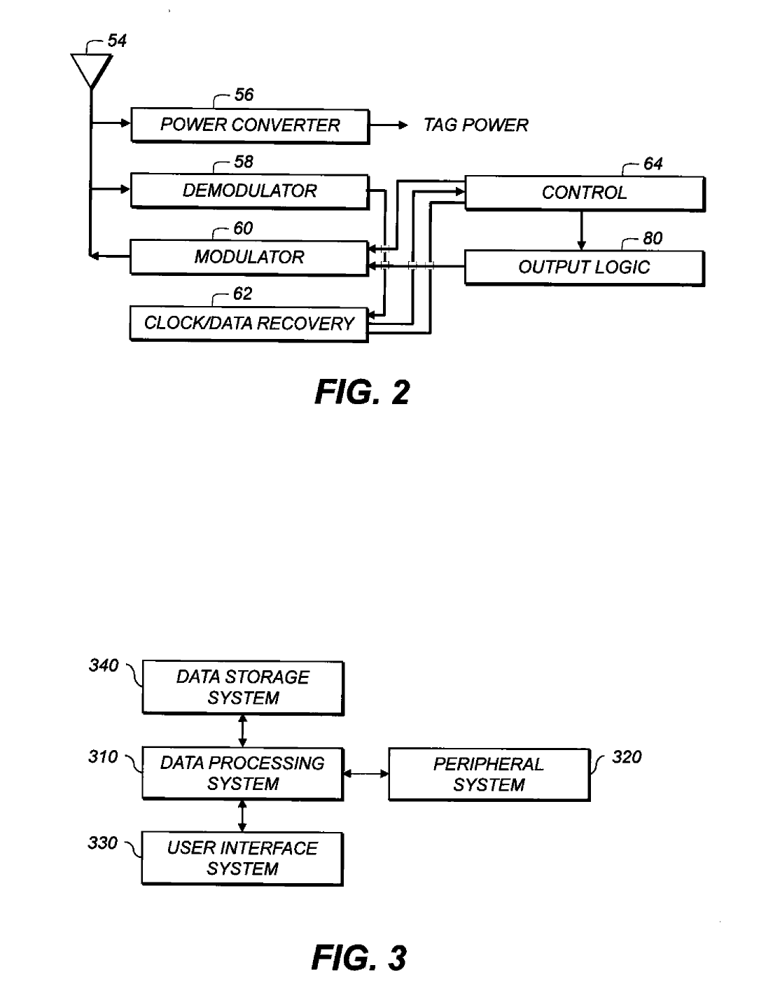

FIG. 2 is a block diagram of a passive RFID tag (e.g., tags 22, 24, 26 according to an embodiment of the system shown in FIG. 1) according to various embodiments. The tag can be a low-power integrated circuit, and can employ a “coil-on-chip” antenna for receiving power and data. The RFID tag includes antenna 54 (or multiple antennas), power converter 56, demodulator 58, modulator 60, clock/data recovery circuit 62, control unit 64, and output logic 80. Antenna 54 can be an omnidirectional antenna impedance-matched to the transmission frequency of reader 14 (FIG. 1). The RFID tag can include a support, for example, a piece of polyimide (e.g., KAPTON) with pressure-sensitive adhesive thereon for affixing to packages. The tag can also include a memory (often RAM in active tags or ROM in passive tags) to record digital data, e.g., an SGTIN.

Reader 14 (FIG. 1) charges the tag by transmitting a charging signal, e.g., a 915 MHz sine wave. When the tag receives the charging signal, power converter 56 stores at least some of the energy being received by antenna 54 in a capacitor, or otherwise stores energy to power the tag during operation.

After charging, reader 14 transmits an instruction signal by modulating onto the carrier signal data for the instruction signal, e.g., to command the tag to reply with a stored SGTIN. Demodulator 58 receives the modulated carrier bearing those instruction signals. Control unit 64 receives instructions from demodulator 58 via clock/data recovery circuit 62, which can derive a clock signal from the received carrier. Control unit 64 determines data to be transmitted to reader 14 and provides it to output logic 80. For example, control unit 64 can retrieve information from a laser-programmable or fusible-link register on the tag. Output logic 80 shifts out the data to be transmitted via modulator 60 to antenna 54. The tag can also include a cryptographic module (not shown). The cryptographic module can calculate secure hashes (e.g., SHA-1) of data or encrypt or decrypt data using public- or private-key encryption. The cryptographic module can also perform the tag side of a Diffie-Hellman or other key exchange.

Signals with various functions can be transmitted; some examples are given in this paragraph. Read signals cause the tag to respond with stored data, e.g., an SGTIN. Command signals cause the tag to perform a specified function (e.g., kill). Authorization signals carry information used to establish that the reader and tag are permitted to communicate with each other.

Passive tags typically transmit data by backscatter modulation to send data to the reader. This is similar to a radar system. Reader 14 continuously produces the RF carrier sine wave. When a tag enters the reader's RF range 52 (FIG. 1; also referred to as a “field of view”) and receives, through its antenna from the carrier signal, sufficient energy to operate, output logic 80 receives data, as discussed above, which is to be backscattered.

Modulator 60 then changes the load impedance seen by the tag's antenna in a time sequence corresponding to the data from output logic 80. Impedance mismatches between the tag antenna and its load (the tag circuitry) cause reflections, which result in momentary fluctuations in the amplitude or phase of the carrier wave bouncing back to reader 14. Reader 14 senses for occurrences and timing of these fluctuations and decodes them to receive the data clocked out by the tag. In various embodiments, modulator 60 includes an output transistor (not shown) that short-circuits the antenna in the time sequence (e.g., short-circuited for a 1 bit, not short-circuited for a 0 bit), or opens or closes the circuit from the antenna to the on-tag load in the time sequence. In another embodiment, modulator 60 connects and disconnects a load capacitor across the antenna in the time sequence. Further details of passive tags and backscatter modulation are provided in U.S. Pat. No. 7,965,189 to Shanks et al. and in “Remotely Powered Addressable UHF RFID Integrated System” by Curty et al., IEEE Journal of Solid-State Circuits, vol. 40, no. 11, November 2005, both of which are incorporated herein by reference. As used herein, both backscatter modulation and active transmissions are considered to be transmissions from the RFID tag. In active transmissions, the RFID tag produces and modulates a transmission carrier signal at the same wavelength or at a different wavelength from the read signals from the reader.

FIG. 3 is a high-level diagram showing the components of a processing system useful with various embodiments. The system includes a data processing system 310, a peripheral system 320, a user interface system 330, and a data storage system 340. Peripheral system 320, user interface system 330 and data storage system 340 are communicatively connected to data processing system 310.

Data processing system 310 includes one or more data processing devices that implement the processes of various embodiments, including the example processes described herein. The phrases “data processing device” or “data processor” are intended to include any data processing device, such as a central processing unit (“CPU”), a desktop computer, a laptop computer, a mainframe computer, a personal digital assistant, a Blackberry™, a digital camera, cellular phone, or any other device for processing data, managing data, or handling data, whether implemented with electrical, magnetic, optical, biological components, or otherwise.

Data storage system 340 includes one or more processor-accessible memories configured to store information, including the information needed to execute the processes of various embodiments. Data storage system 340 can be a distributed processor-accessible memory system including multiple processor-accessible memories communicatively connected to data processing system 310 via a plurality of computers or devices. Data storage system 340 can also include one or more processor-accessible memories located within a single data processor or device. A “processor-accessible memory” is any processor-accessible data storage device, whether volatile or nonvolatile, electronic, magnetic, optical, or otherwise, including but not limited to, registers, floppy disks, hard disks, Compact Discs, DVDs, flash memories, ROMs, and RAMs.

The phrase “communicatively connected” refers to any type of connection, wired or wireless, between devices, data processors, or programs in which data can be communicated. This phrase includes connections between devices or programs within a single data processor, between devices or programs located in different data processors, and between devices not located in data processors at all. Therefore, peripheral system 320, user interface system 330, and data storage system 340 can be included or stored completely or partially within data processing system 310.

Peripheral system 320 can include one or more devices configured to provide digital content records to data processing system 310, e.g., digital still cameras, digital video cameras, cellular phones, or other data processors. Data processing system 310, upon receipt of digital content records from a device in peripheral system 320, can store such digital content records in data storage system 340. Peripheral system 320 can also include a printer interface for causing a printer to produce output corresponding to digital content records stored in data storage system 340 or produced by data processing system 310.

User interface system 330 can include a mouse, a keyboard, another computer, or any device or combination of devices from which data is input to data processing system 310. Peripheral system 320 can be included as part of user interface system 330. User interface system 330 also can include a display device, a processor-accessible memory, or any device or combination of devices to which data is output by data processing system 310. If user interface system 330 includes a processor-accessible memory, such memory can be part of data storage system 340 even though user interface system 330 and data storage system 340 are shown separately in FIG. 1.

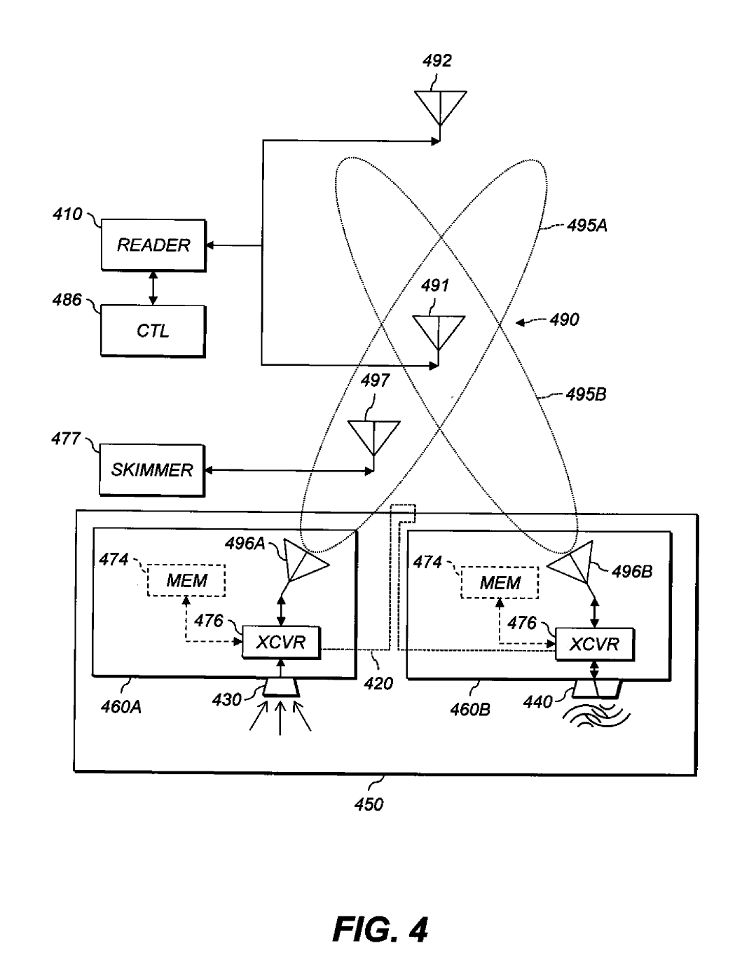

FIG. 4 shows radio-frequency identification (RFID) apparatus according to various embodiments.

Object 450 is a non-RFID-active object: object 450 does not respond to queries from RFID reader 410. Object 450 can be a container or shipping crate. Object 450 can block or attenuate RF energy, or not. Two RFID tags 460A, 460B are affixed to object 450 at respective, different tag locations. Tags 460A, 460B can each be active (self-powered in whole or in part) or passive (scavenging power from the RF signal from reader 410). Either tag 460A or 460B can include a memory. Each tag 460A, 460B includes respective directional antenna 496A, 496B. Antennas 496A, 496B can be mechanically separated from other components of tag 460A, 460B, and connected thereto through a feedline.

Antennas 496A, 49613 can be implemented using various directional-antenna technologies. They can be phased-array antennas or not. They can be steered electrically, e.g., by adjusting the time of transmission from each element of a phased-array antenna. They can also be steered mechanically, e.g., by rotating a Yagi or other directional antenna on a mount. Each antenna 496A, 496B transmits in a respective, different direction to define respective directional propagation patterns 495A, 495B. Elliptical propagation patterns 495A, 495B are shown for clarity in the drawing; physical propagation patterns 495A, 49513 can be more complexly shaped.

Reader location 490 is defined in the intersection of propagation patterns 495A, 495B. Reader location 490 can be a point, line, area, volume, or other shape. The term “intersection” refers to the volume of space in which RF signals can be transmitted to, and received from, tag antennas 496A, 496B with signal-to-noise ratios (SNR) exceeding a selected threshold (e.g., 40 dB). Components of reader 410 other than antenna 491 can be located away from reader location 490. Antenna 491 can be located away from reader location 490 as long as a suitable waveguide or other structure is provided to convey RF energy from reader location 490 to reader antenna 491.

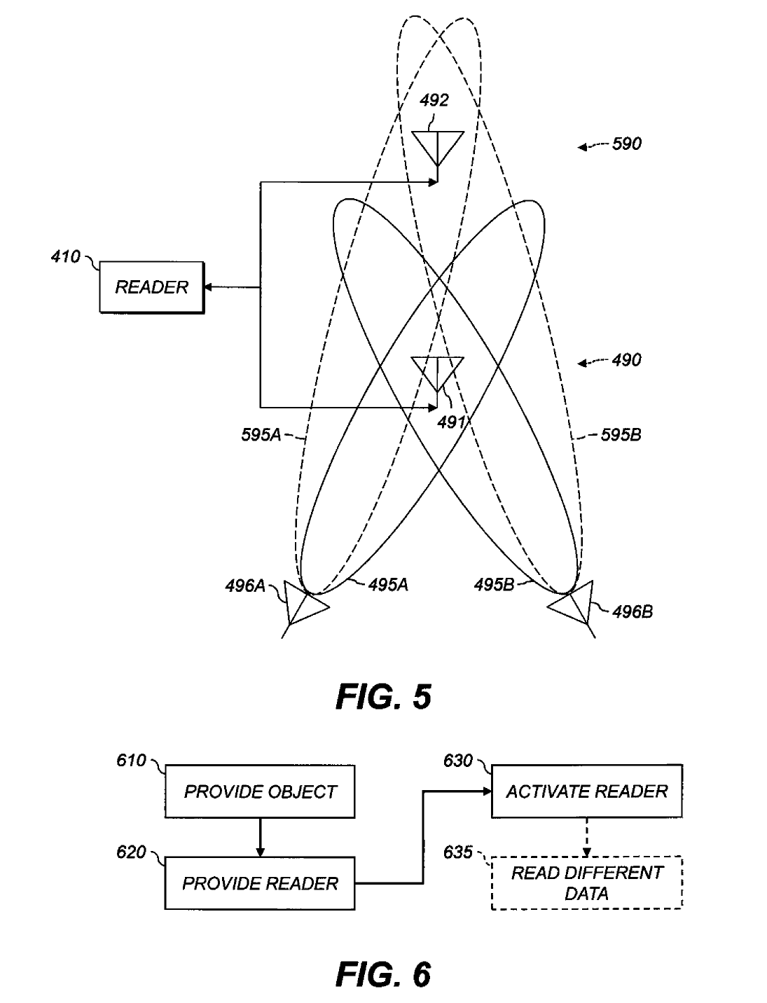

RFID reader 410 is connected to reader antenna 491 located at the reader location i.e., somewhere within the volume of the intersection. Reader 410 communicates with tags 460A, 460B on behalf of controller 486. Controller 486 can be or include a microprocessor, microcontroller, FPGA, PAL, PLA, PLD, ASIC, or other logic or processing device. In various embodiments, reader 410 is also connected to reader antenna 492, which is not located at reader location 490, as will be discussed below with reference to FIG. 5. In various embodiments, reader antenna 492 has a substantially omnidirectional propagation pattern, or has a substantially omnidirectional propagation pattern in a plane including tag antennas 496A, 496B. For example, reader antenna 492 can be a straight whip antenna or dipole antenna. In these antenna types, radiation is not concentrated by the design of the antenna into a single main lobe.

Skimmer 477 is an unauthorized reader, using skimmer antenna 497 to attempt to communicate with tags 460A, 460B. In this example, skimmer antenna 497 is in propagation pattern 495A, but not propagation pattern 495B. Therefore, skimmer 477 cannot communicate with tag 460B.

Even if skimmer 477 uses a very high power to attempt to communicate with tag 460B, the responses of tag 460B will be attenuated by the directionality of antenna 496B, reducing the SNR present at tag 460A or received at skimmer 477. In various embodiments, tag antennas 496A, 496B have propagation patterns 495A, 495B with a main lobe oriented in a particular direction, and one or more side lobes with power levels −20 dB or lower with respect to the main lobe. In an example, the tag antenna can have a 3 dB beamwidth of approximately 0.5° and a first side lobe level of approximately −22 dB. Further examples of directional antennas that can be used with various embodiments are given in U.S. Pat. No. 7,501,982 to Charash et al., U.S. Pat. No. 6,167,286 to Ward et al., and U.S. Pat. No. 6,337,628 to Campana, all of which are incorporated herein by reference.

In various embodiments, RFID tags 460A, 460B are passive tags. Therefore, skimmer 477 must broadcast high enough power to activate the tag notwithstanding the attenuation of antenna 496B at its angle to skimmer antenna 497. Skimmer 477 must also have high enough receive sensitivity to hear the backscattered response from the tag through the attenuation of antenna 496B and the noise present, including the noise produced by skimmer 477 itself while transmitting. This advantageously significantly reduces the likelihood that skimmer 477 will be able to communicate with tag 460B.

Tags 460A, 460B include respective transceivers 476 that communicate with reader 410 via antennas 496A, 496B. Each tag 460A, 460B can include memory 474, which can be volatile or non-volatile, and can include RAM, ROM, PROM, EPROM, EEPROM, Flash memory, spin-change memory, MRAM, FRAM, flip-flops, or any other memory technology.

In various embodiments, object 450 is a container. In an example, a plurality of intermodal containers (e.g., 53′ shipping containers) can have respective RFID tags 460A, 460B. Tags 460A, 460B can be mounted the same distance apart on any container (object 450), but with different orientations of tag antennas 496A, 496B. Consequently, different containers will have differently-oriented propagation patterns 495A, 495B, and thus different reader locations 490. The position of reader location 490 can encode information about what type or size of container object 450 is. For example, different reader locations can correspond to different lengths of container, or one reader location can correspond to normal-height and another to high-cube. In various embodiments, antennas 496A, 496B are oriented to project at an angle of 45° from the normal to the container at the respective tag. As a result, propagation patterns 495A, 495B are substantially at right angles at reader location 490. This provides a well-localized reader location 490.

In various embodiments, object 450 is a container. A selected tag (e.g., tag 460A) includes light sensor 430 disposed in or facing the interior of object 450. Tag 460A monitors a light level in the container using light sensor 430. When the light level in the container (object 450) increases by 100% in less than five seconds, tag 460A records a door-open event in memory 474.

In various embodiments, object 450 is a container including a door (not shown). RFID tags 460A, 460B are electrically connected across the door opening using electrical conductor 420. Conductor 420 thus breaks when the door is opened. Either tag 460A, 460B can store in memory an indication of whether conductor 420 is broken. Alternatively, when queried by reader 410, either tag can detect the continuity of conductor 420 and report to reader 410 appropriately. In various embodiments, conductor 420 is further wrapped around at least two sides of the container (object 450). In other embodiments, conductor 420 is a loop connected to two separate connection points on a single tag (e.g., tag 460A or 460B). Tag 460A (respectively 460B) can measure conductor 420 by time-domain reflectometry (TDR) to determine if a break is closer than a selected distance to the other RFID tag 460B (resp. 460A). Tags 460A or 460B can also apply selected test currents to conductor 420, and each tag can detect current from the other as an indication of continuity.

In various embodiments, object 450 is a container. A selected one of the RFID tags, here tag 460B, includes memory 474. Tag 460B includes or is connected to ultrasonic transducer 440, which it uses to monitor the contents of the container (object 450). When the sonic time-of-flight in the container changes by 50%, tag 460B records a contents-changed event in memory 474.

FIG. 5 shows antenna configurations according to various embodiments. Reader 410, reader antenna 491, tag antennas 496A, 496B, propagation patterns 495A, 495B, and reader location 490 are as shown in FIG. 4. Reader is also connected to antenna 492 at second reader location 590 different from location 490. Reader location 590 is at the intersection of propagation pattern 595A, from antenna 496A, and propagation pattern 595B, from antenna 496B. As will be discussed below, reader antenna 491 can be moved between reader locations 490, 590, or two reader antennas 491, 492 can be used to determine which propagation pattern set (495A, 495B or 595A, 595B) is in use by antennas 496A, 496B.

FIG. 6 shows methods of reading a plurality of RFID tags using an RFID reader according to various embodiments. Processing begins with step 610.

In step 610, a non-RFID-active object is provided. The object can be a container or shipping crate, or an instance of a product. The non-RFID-active object does not itself communicate using RF energy, and it can block RF or not. The object has two RFID tags affixed thereto at respective, different tag locations. Each tag includes (or is connected to via a feed line) a respective directional antenna steered in a respective, different direction. Respective directional propagation patterns are thus defined and a reader location is defined in the intersection of the propagation patterns. An example of such an object and related components is shown in FIG. 4; other configurations are possible. Step 610 is followed by step 620.

In step 620, an RFID reader is provided. The reader has a reader antenna located at, i.e., somewhere within, the reader location. Step 620 is followed by step 630.

In step 630, the RFID reader is activated to read both tags. The RFID reader can attempt to communicate with the tags simultaneously or sequentially. Tag inventory can be carried out, e.g., as described in the EPCglobal Class-1 Gen-2 UHF RFID protocol specification. Tag inventory permits the reader to determine which tags are in range, and to select a particular tag with which to communicate. Step 630 can include optional step 635.

In optional step 635, activating step 630 includes reading respective, different data from the two tags. In various embodiments, information about the object (e.g., its SGTIN) is divided between the two tags. The reader reads a portion of the SGTIN from each tag to determine the SGTIN of the object. Consequently, it is difficult for a skimmer with an antenna not at the reader location (e.g., as shown in FIG. 4) to determine the whole SGTIN.

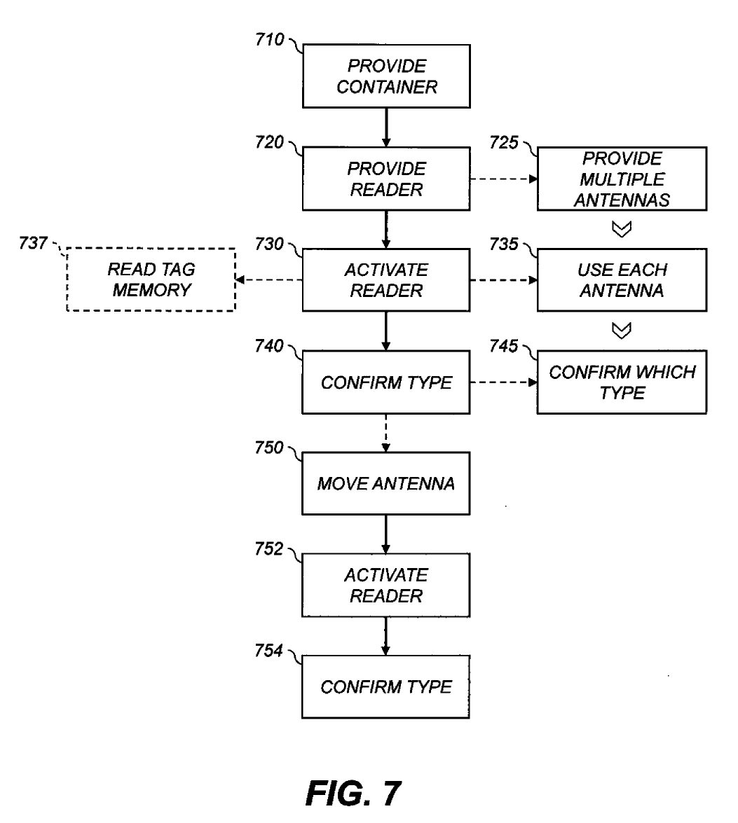

FIG. 7 shows various embodiments of methods of identifying a type of a container, or of testing whether a container is of a particular type. The container can be of any size, shape. In various embodiments, the container is a non-RFID-active object, as defined above. Processing begins with step 710.

In step 710, the container is provided. The container has two RFID tags affixed thereto at respective, different tag locations, each tag including a respective directional antenna steered in a respective, different direction, so that respective directional propagation patterns are defined and a reader location is defined in the intersection of the propagation patterns. Examples of container configurations useful with this method are given in FIGS. 4 and 5, discussed above. Step 710 is followed by step 720.

In step 720, an RFID reader is provided with a reader antenna located in the reader location. Step 720 can include optional step 725, and is followed by step 730.

In step 725, the RFID reader is provided with a plurality of antennas located in respective, different reader locations.

In step 730, the RFID reader is activated to attempt to read both tags. Step 730 can include optional steps 735 or 737 (discussed below), and is followed by step 740.

Step 735 is useful when the reader has multiple antennas (step 725), as represented graphically by the chevrons. The reader is activated to attempt to read both tags using each antenna. The antennas can be activated simultaneously or sequentially.

In step 740, a controller automatically determines that the container is of a selected type if both tags are read, and that the container is not of the selected type if either tag is not read. Step 740 can include optional step 745, and is optionally followed by step 750.

Step 745 is useful when the reader has multiple antennas (step 725). The controller determines on which antenna both tags were read, if any, and determined that the container is of a selected type corresponding to that antenna. This determination can be made using a lookup table. Continuing the above example of an intermodal container, in various embodiments, the lookup table can map reader location 490 (FIG. 5) to a normal-height container and reader location 590 (FIG. 5) to a high-cube container. If neither antenna reads both tags, the controller determines the container is untagged, has been mis-oriented, has been tampered with, or is of an unknown type.

In various embodiments, the determining step includes determining that the container is of a selected type only if both tags were read on only one of the antennas. A skimmer trying to spoof an RFID tag can broadcast omnidirectionally, in which case more than one reader antenna can receive the spoofed signal. The controller can determine that a skimmer is present if signals appearing to be from both RFID tags are received on each of at least two antennas, or if signals appearing to be from one RFID tag are received at power levels that differ by less than a selected threshold. The threshold can be selected based on the geometry and typical power levels of the system. For example, if a purported tag signal is received at substantially equal power by two antennas, only one of which is at the reader location, the controller can determine a spoofer is present.

Steps 750, 752, and 754 can optionally be performed. These steps can be useful with readers having only one antenna. In step 750, if the two tags were not read in step 730, the reader antenna is moved to a second reader location. Step 750 is followed by step 752. In step 752, the RFID reader is activated to attempt to read both tags. Step 752 is followed by step 754. In step 754, the controller automatically determines that the container is of a second selected type if both tags are read, and that the container is not of the second selected type if either tag is not read. A lookup table can be used to determine which type corresponds to each antenna location.

In step 737, the memory of a selected one or more tag(s) is read. This step can be used with embodiments such as those described above in which the tag stores an indication of a condition in memory. In an example, the tag monitors a light level in the container and records a door-open event in memory if the light level rises suddenly. Step 737 includes reading the memory of the selected tag to determine whether a door-open event occurred.

In another example using conductor 420 (FIG. 4), step 737 includes reading from at least one of the tags an indication of whether the electrical conductor has broken.

In yet another example, the tag monitors the contents of the container using an ultrasonic transducer. Step 737 includes reading the tag's memory to determine whether a contents-changed event is recorded therein.

These examples can be used together in any combination, along with other examples and other data a tag can store in memory.

The invention is inclusive of combinations of the embodiments described herein. References to “a particular embodiment” and the like refer to features that are present in at least one embodiment of the invention. Separate references to “an embodiment” or “particular embodiments” or the like do not necessarily refer to the same embodiment or embodiments; however, such embodiments are not mutually exclusive, unless so indicated or as are readily apparent to one of skill in the art. The use of singular or plural in referring to the “method” or “methods” and the like is not limiting. The word “or” is used in this disclosure in a non-exclusive sense, unless otherwise explicitly noted.

The invention has been described in detail with particular reference to certain preferred embodiments thereof, but it will be understood that variations, combinations, and modifications can be effected by a person of ordinary skill in the art within the spirit and scope of the invention.

### PARTS LIST

10 base station
12 air interface
14 reader
16 reader's antenna
18 memory unit
20 logic unit
22, 24, 26 RFID tag
30, 44, 48 antenna
42 RF station
52 range
54 antenna
56 power converter
58 demodulator
60 modulator
62 clock/data recovery circuit
64 control unit
80 output logic
310 data processing system
320 peripheral system
330 user interface system
340 data storage system
410 RFID reader
420 conductor
430 light sensor
440 ultrasonic transducer
450 object
460A, 460B RFID tag
474 memory
476 transceiver
477 skimmer
486 controller
490 reader location
491, 492 reader antenna
495A, 495B propagation pattern
496A, 496B tag antenna
497 skimmer antenna
590 reader location
595A, 595B propagation pattern
610 provide object step
620 provide reader step
630 activate reader step
635 read different data step
710 provide container step
720 provide reader step
725 provide multiple antennas step
730 activate reader step
735 use each antenna step
737 read tag memory step
740 confirm type step
745 confirm which type step
750 move antenna step
752 activate reader step
754 confirm type step

1. A method of identifying a type of a container, the method comprising:
providing the container having two RFID tags affixed thereto at respective, different tag locations, each tag including a respective directional antenna steered in a respective, different direction, so that respective directional propagation patterns are defined and a reader location is defined in an intersection of the propagation patterns;
providing an RFID reader with a reader antenna located in the reader location;
activating the RFID reader to attempt to read both tags; and
using a controller, automatically determining that the container is of a selected type if both tags are read, and that the container is not of the selected type if either tag is not read.

2. The method according to claim 1, further including moving the reader antenna to a second reader location, activating the RFID reader to attempt to read both tags; and, using the controller, automatically determining that the container is of a second selected type if both tags are read, and that the container is not of the second selected type if either tag is not read.

3. The method according to claim 1, wherein the reader-providing step includes providing the RFID reader with a plurality of antennas located in respective, different reader locations, the activating step includes activating the reader to attempt to read both tags using each antenna, and the determining step includes determining on which antenna both tags were read, and determining that the container is of a selected type corresponding to that antenna.

4. The method according to claim 3, wherein the determining step includes determining that the container is of a selected type only if both tags were read on only one of the antennas.

5. The method according to claim 1, wherein a selected one of the RFID tags includes a memory, further including the selected tag's monitoring a light level in the container, so that when the light level in the container increases by 100% in less than five seconds, the tag records a door-open event in the memory, wherein the activating step includes reading the memory of the selected tag.

6. The method according to claim 1, wherein the container includes a door, the providing step further including electrically connecting the two RFID tags across the door opening using an electrical conductor, so that the electrical conductor breaks when the door is opened, and the activating step includes reading from at least one of the tags an indication of whether the electrical conductor has broken.

7. The method according to claim 6, wherein the conductor is further wrapped around at least two sides of the container.

8. The method according to claim 1, wherein a selected one of the RFID tags includes a memory, further including the selected tag's monitoring the contents of the container using an ultrasonic transducer, so that when the sonic time-of-flight in the container changes by 50%, the tag records a contents-changed event in the memory, wherein the activating step includes reading the memory of the selected tag.

9. The method according to claim 1, wherein the RFID tags are passive tags.

10. A method of reading a plurality of RFID tags using an RFID reader, comprising:
providing a non-RFID-active object having two RFID tags affixed thereto at respective, different tag locations, each tag including a respective directional antenna steered in a respective, different direction, so that respective directional propagation patterns are defined and a reader location is defined in the intersection of the propagation patterns;
providing an RFID reader with a reader antenna located at the reader location; and
activating the RFID reader to read both tags.

11. The method according to claim 10, wherein the reader antenna is omnidirectional.

12. The method according to claim 10, wherein the activating step includes reading respective, different data from the two tags.

13. The method according to claim 10, wherein the RFID tags are passive tags.
